(19) United States
(12) Patent Application Publication
(10) Pub. No.: US 2005/0262224 A1
(43) Pub. Date: Nov. 24, 2005

(54) Method for modifying one or more parameters for the operation of a network and subscribers for carrying out this method

(75) Inventors: Otmar Katzenberger, Buehl (DE); Frederic Scherer, Rittershoffen (FR)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 11/101,438

(22) Filed: Apr. 8, 2005

Related U.S. Application Data
(63) Continuation of application No. PCT/DE03/03333, filed on Oct. 8, 2003.

(30) Foreign Application Priority Data
Oct. 8, 2002 (DE) 102 468 95.8

(51) Int. Cl. G06F 15/177

(52) U.S. Cl. 709/220

(57) ABSTRACT

A method for modifying one or more parameters for the operation of a network, especially based on the PROFIBUS specification. In particular, a method for enabling an automatic reparameterization of all of the users in the network. A central user (1) sends a request message (T1) for parameter modification to the other users (2 . . . 5) in the network. The users (1 . . . 5) then go into an offline state for a predeterminable minimum duration and revert back to the online state with the new operating parameterization The respective minimum duration of the offline state is preset such that users with different operating parameterizations are at no time simultaneously in the online state. Further measures can render the method fault-tolerant.

This is a Continuation of International Application PCT/DE2003/003333, with an international filing date of Oct. 8, 2003, which was published under PCT Article 21(2) in German, and the disclosure of which is incorporated into this application by reference.

### FIELD AND BACKGROUND OF THE INVENTION

1. Field of the Invention

The present invention relates to a method for modifying one or more parameters for the operation of a network. In particular, the present invention relates to a method for modifying one or more parameters for the operation of a based on the PROFIBUS specification, and one or more users for carrying out this method of modifying one or more parameters.

2. Description of Related Art

A network is a communication system used for the transmission of data between different devices, for example, devices distributed over different locations in an automation system. In principle, the network can have any topology. The users of the network are devices participating in the data communication within the network. For example, a network may be the PROFIBUS (process field bus), which is an open bus system for the communication among field devices within an automation system standardized under the European standard EN 50170 Vol. 2, incorporated herein by reference.

In a network such as the PROFIBUS, certain parameters must be identical in all the individual devices of the network for the data communication to be possible. Parameters essential for the operation of PROFIBUS are, for example, the slot time and the baud rate.

In automation systems with a plurality of networked devices it may become necessary from time to time to reparameterize the network, i.e., to reset the parameters in the network. If this reparameterization also modifies a set of parameters or a parameter which is used to control data communication and which is identical for all of the users in the network, particularly, an essential parameter such as the baud rate, a permanent network fault may occur. This fault occurs as soon as the first user with new operating parameters returns to the online state, while the remaining users still work with the old operating parameters. That is, if, in the PROFIBUS network, the baud rate is changed for one of the users, e.g., the central unit, while the other users still work with the old parameters, when the user with a changed baud rate returns online, the two different baud rates collide. As a result, the central unit can no longer reach the other users. Data communication within a PROFIBUS network requires that all of the users in the network handle the message traffic at the same transmission rate, i.e., at the same baud rate. Different baud rates lead to a permanent fault because the users can no longer be correctly synchronized so as to communicate with each other.

To prevent this permanent fault, a reconfiguration of the system that involves the modification of essential operating parameters requires an operator to “manually” change the operating parameters in each individual user. To perform this reparameterization, all of the users in the network must be successively brought offline so that they no longer participate in the message traffic. These offline users are then configured with the new parameters or parameter. Next, to return to the online state, all of the users in the network must then be restarted with the new operating parameters. Only after all of the users in the network adopted the new parameters, in the manner described above, can the central user transmit through the network further configuration information such as connection lists or data records to each of the other users, which are operational again.

### OBJECT OF THE INVENTION

One object of the present invention is to provide a method for modifying a parameter or parameters for the operation of a network, particularly a network based on the PROFIBUS specification, and to provide a user for executing this method. That is, to provide a method that reduces the substantial efforts involved in reparameterization of the users in the network and a user performing this method.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an exemplary, non-limiting formulation of the present invention, a method for modifying a parameter for an operation of a network having a number of users is provided. The method includes initiating, by a central user, the parameter modification, by sending a request message for the modification of the parameter during the network operation to other users in the network. The method further includes the central user going to an offline state for a first predefined minimum period of time, during which the central user does not take part in data traffic within the network and after receiving the request message, the other users go into the offline state for a second predefined minimum period of time. Furthermore, the method includes after elapse of the first predefined minimum period of time, the central user returning to an online state with a new operating parameterization, and after elapse of the second predefined minimum period of time, the other users returning to the online state with the new operating parameterization. In the method, the first and the second minimum periods of time for the offline state are specified such that the users with different operating parameterizations are not simultaneously in the online state.

According to another illustrative, non-limiting formulation of the present invention, a user for carrying out a method for modifying a parameter for an operation of a network is provided. The user has modules for being configured as a central user and/or as the other user. When the user is configured as a central user, the user: a) initiates the parameter modification by sending a request message for the parameter modification to the other users during the network operation, b) after sending the request message, the central user switches to an offline state for a predefined minimum period of time during which the central user does not take part in data traffic within the network, and c)_after an elapse of the predefined minimum period of time, the central user returns to the offline state with the new operating parameterization. On the other hand, when the user is configured as one of the other users, the user: a) goes into an offline state for a second predefined minimum period of time after receiving the request message and b) the other user returns to the online state with the new operating parameterization after elapse of the second predefined minimum period of time. The first and the second minimum period of times for the offline state are set so that the users with different operating parameterizations are not in the online state simultaneously.

Preferably, according to the exemplary, non-limiting formulation of the present invention, the parameters essential for the operation of the network can be modified with only a short interruption of the data traffic, that is, quasi online. Time-consuming manual interventions in the individual network users are not required. This method may simplify the reconfiguration of a network with the modified operating parameters, particularly if the number of users is high and the network is extensive. Particularly, in a PROFIBUS network, the baud rate or the slot time may be modified without manual interventions into the operation of the individual users. This may reduce the time required to perform the reconfiguration of the network and the manpower required.

According to a variation of the illustrative, non-limiting formulation of the present invention, any faults that may have occurred during the modification of the operating parameters may be detected by the central user. That is, after returning to the online state, the central user checks by a query message whether all of the other users in the network have returned to the online state with the new operating parameterization. This check allows for suitable fault correction measures if some of the users are not located.

Preferably, the method according to the exemplary, non-limiting formulation of the present invention can be made fault-tolerant. Particularly, in the event that all of the other users have returned to the online state with the new operating parameterization, the central user sends a confirmation message to the other users to inform them that the parameterization has been completed successfully. In an event of an error, that is, if at least one of the other users has not returned to the online state with the new operating parameterization, the central user sends no such confirmation message to the other users. If the other users do not receive a confirmation message within a certain time interval, these other users recognize that a fault has occurred in the reconfiguration of the network. Accordingly, the other users go into the offline state, readopt the old operating parameters, and return to the online state. Thus, the original state of the network before the start of the procedure is restored.

This fault-tolerant procedure ensures that no permanent fault occurs and that the system remains operational even if a fault in the reconfiguration does occur. This fault-tolerant procedure is especially preferable in the reconfiguration of the devices in the automation systems, since any system downtime caused by the communication failures would entail significant costs.

According, to a variation of an illustrative, non-limiting formulation of the present invention, the other users may acknowledge the receipt of the confirmation message sent by the center user. If the other users acknowledge receipt of the confirmation message sent by the central user, an additional check is performed. This additional check is to establish that data communication over the network is effected with the new operating parameters, since all of the users in the network have sent and received at least one message.

The method according to the illustrative formulation may be particularly fast if the central user simultaneously sends the request message as a broadcast message to all of the other users in the network. The adoption of the new operating parameterization is thus effected simultaneously for all of the users.

As an alternative, the request message can be addressed to, and acknowledged by each of the other users, separately, i.e., individual messages as opposed to a broadcast message. In the event of the individual request messages, a request message is sent successively to each of the other users in the network. This handshaking procedure in message traffic produces a return message from each user addressed, thereby improving operational reliability.

### BRIEF DESCRIPTION OF THE DRAWINGS

The present invention will now be described in detail by describing an illustrative, non-limiting embodiment thereof with reference to the accompanying drawings. In the drawings, the same reference characters denote analogous elements:

FIG. 1 is a structural diagram illustrating a network with a number of users according to an exemplary, non-limiting embodiment of the present invention,

FIG. 2 is a flow chart illustrating a method of reconfiguring one or more parameters of the network for a central user according to an exemplary, non-limiting embodiment of the present invention, and

FIG. 3 is a flow chart illustrating a method of reconfiguring one or more parameters for one of the other users according to the embodiment of the present invention.

### DETAILED DESCRIPTION OF ILLUSTRATIVE, NON-LIMITING EMBODIMENTS

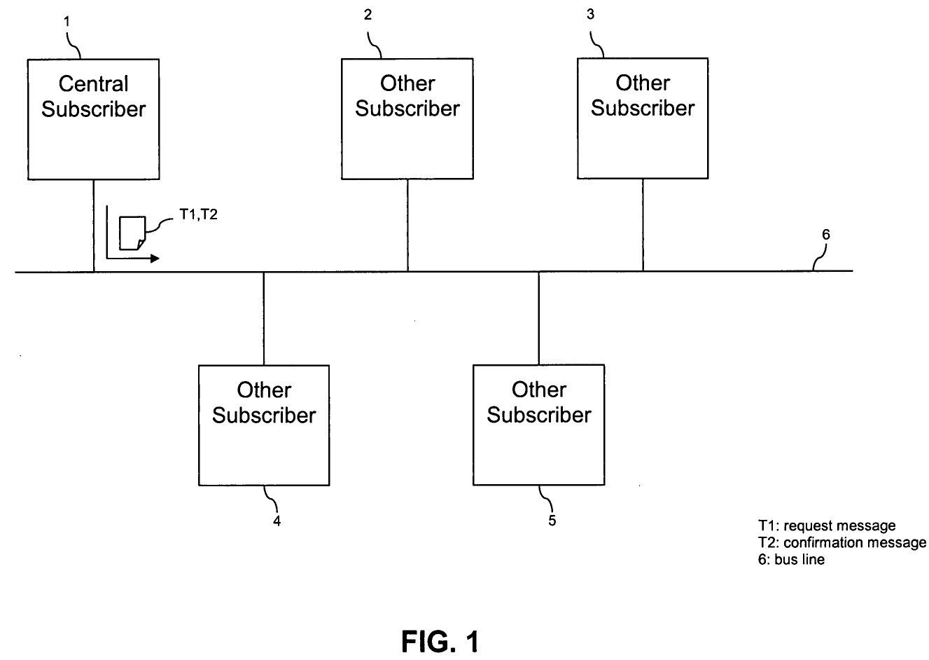

According to FIG. 1, users or subscribers 1 . . . 5 are interconnected in a network for data communication. In order to communicate with each other in the network, the users 1 . . . 5 each have a bus interface to which a bus line 6 is connected. In the exemplary embodiment depicted in FIG. 1, the user 1 is an automation device, and the users 2 . . . 5 are field devices of an automation system. The exemplary network depicted in FIG. 1 satisfies the PROFIBUS specification. The user 1 performs the function of a central user, which initiates the procedure for modifying the operating parameterization of the users 1 . . . 5. The users 2 . . . 5 are referred to as the other users. This functional assignment (i.e., the user 1 being a central user and the users 2 . . . 5 being the other users) is maintained for the duration of the reconfiguration procedure. Thereafter, however, this functional assignment may be changed.

The following description of the procedure assumes that only the central user, i.e., in the example depicted in FIG. 1 the user 1, has access to a system configuration. Moreover, only the central user initiates a reparameterization of the users 1 . . . 5 by sending a request message T1 depicted in FIG. 1 and then, after the users 1 . . . 5 go back online, sending a confirmation message T2 also depicted in FIG. 1. Furthermore, if the operating parameters are to be modified, the central user, i.e., the user 1 depicted in FIG. 1, first checks whether the modification of the configuration will also cause the current set of network parameters that is uniform for all of the users 1 . . . 5 to be modified. If elementary parameters, i.e., parameters essential for operation that are the same for all of the users 1 . . . 5, such as the baud rate, are changed by the reconfiguration, the procedure described in greater detail below is used to modify a parameter for the operation of the network.

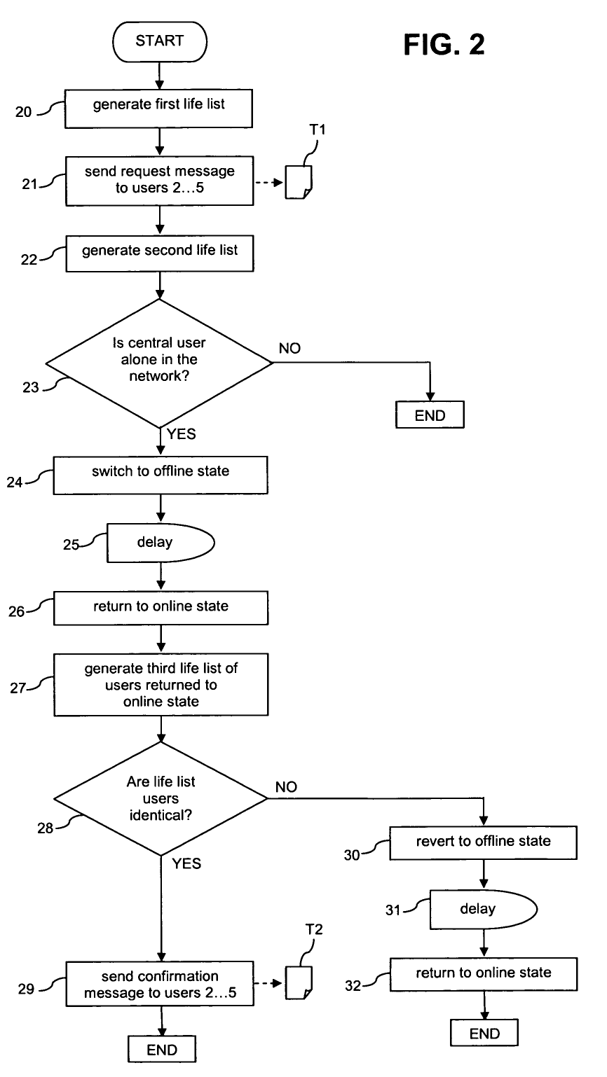

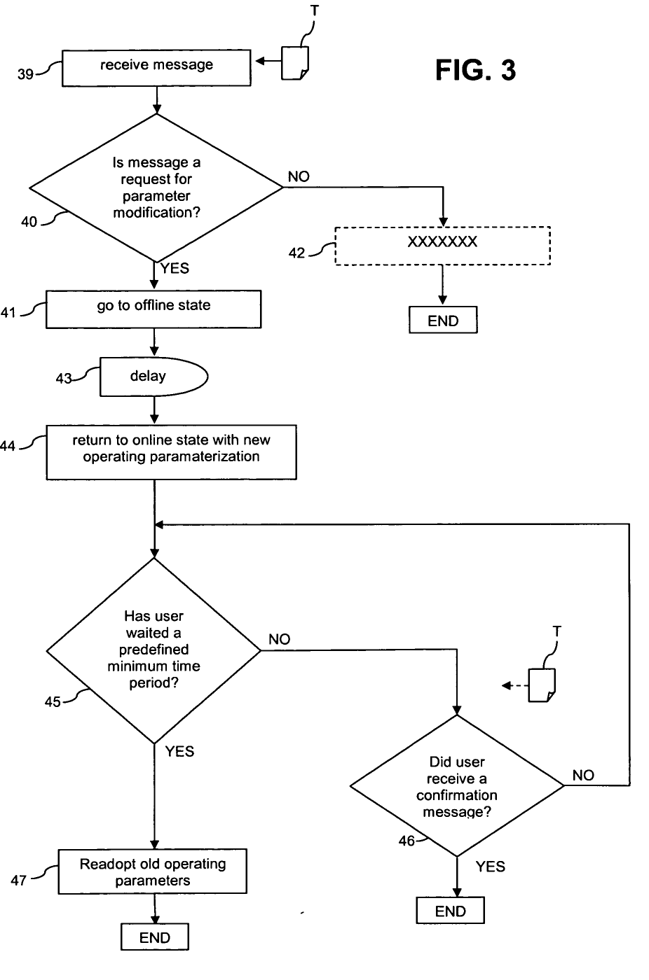

To explain the procedure of reconfiguration according to the exemplary, non-limiting embodiment of the present invention in greater detail, FIGS. 2 and 3 show diagrams of the basic procedural sequence for the central user 1 and, by way of example, for a user 2 as one of the other users 2 . . . 5. Specifically, FIG. 2 illustrates the basic procedure sequence for the central user 1 and FIG. 3 illustrates the basic procedure for the other user 2. Hence, the procedure of reconfiguration is explained with reference to FIGS. 2 and 3, interchangeably.

The reconfiguration procedure begins with a “start” depicted in FIG. 2. To enable a subsequent detection of faults in the procedural sequence, the central user 1 first generates a so-called life list. PROFIBUS offers an FDL or field data link service for the generation of the life list. The FDL provides a current list of the operational users existing in the network. The first life list is generated by the central user 1 in a step 20 as shown in FIG. 2. Thereafter, the central user 1 sends a request message T1 to the other users 2 . . . 5 in step 21. With this message T1, the user 2, for example, is informed that a reparameterization of the network is to occur. At the same time, the operating parameters are transmitted.

Next, the basic procedure sequence of the other user 2 begins with receiving a message T from the central user 1 as depicted in step 39 of FIG. 3. Then, the user 2 evaluates the received message T in a query 40 (step 40 depicted in FIG. 3) to determine whether it is a request message T1 for parameter modification. If a request message T1 was received, then the actual procedure starts and the user 2 goes to an offline state in step 41. That is, the user 2 does not take part in the data traffic of the network. Otherwise, the user 2 performs other actions which are executed in normal operation based on the respective application as depicted in FIG. 3 in a step 42 with XXXXs. These actions are not relevant to the method described here, however.

After a short waiting period giving all the other users 2 . . . 5 enough time to go into the online state, the central user 1 generates a second life list in step 22 depicted in FIG. 2. This second life list is empty if all of the other users 2 . . . 5 support the procedure. That is, the second life list is empty because all of the other users 2 . . . 5 went offline. A query 23 (step 23 depicted in FIG. 2) thus determines whether the central user 1 is alone in the network. If the central user 1 is not alone in the network, then the central user 1 aborts the procedure at this point and keeps the old operating parameterization that was in effect before the procedure was started as illustrated in FIG. 2 with an END stemming from the query 23. The desired modification of the operating parameterization must then be carried out at in a conventional, e.g., manual, manner.

Generating a second life list, as described above, and comparing this second life list with the initially generated first life list is necessary only if it is not possible to ensure in advance that all of the users in the network support the reconfiguration procedure according to the exemplary, non-limiting embodiment of the present invention. If it is possible to ensure in advance that all of the users in the network support this reconfiguration procedure, then the generation of the second list at step 22 and the query at step 23 may be omitted.

Furthermore, the steps 22 and 23 used to query the other users to establish whether they support the procedure for parameter modification can be replaced with an alternative check procedure. For example, the central user could send a multicast message requesting that all of the other users in the network return a data message. The data of this reply message could then include the bus address of the replying user plus a code to indicate whether the respective user supports the reconfiguration procedure according to the exemplary embodiment of the present invention. This alternative would have the drawback, however, that a number of reply messages corresponding to the number of the other users would have to be transmitted over the network, and each of these transmitted reply messages would need to be evaluated. Depending on the size of the network, this might involve a substantial amount of time.

After checking the second life list in the query 23 as depicted in FIG. 2, and ensuring that the central user 1 is alone in the network, the central user 1 switches to the offline state in step 24 depicted in FIG. 2. The central user 1 remains in the offline state until a predefined minimum period of time depicted as delay in step 25 of FIG. 2 has elapsed. The user 2 likewise remains in the offline state for a predefined minimum time period, as illustrated in FIG. 3 by a delay in step 43.

In setting these predetermined periods of time, the fact that the users 1 . . . 5 connected to the network respond at different rates is taken into account. The users 1 . . . 5 may respond at different rates because of the differences in the device behavior or in the processing environments. The wait time (these predetermined periods of time) is governed by the slowest of the users. Although the wait time does not need to be the same in all of the users in the network, the wait time must be selected so that all of the users in the network can go into the offline state before any other user returns to the online state with the new operating parameterization. The metering of the wait time can be started, for example, in the user 1 with the transmission of the message T1 and in the users 2 . . . 5 with the receipt of the message T1.

After the elapse of the set minimum period of time, i.e., the wait time, the users return to the online state with a new operating parameterization. For the central user 1 this occurs in a step 26 of FIG. 2 and for the user 2 in a step 44 of FIG. 3. Once the users 1 . . . 5 go back online with the new operating parameters, the reconfiguration, i.e., modification of the operating parameterization of the network users is completed. The subsequent steps are used for fault detection and fault processing and may be carried out to at least increase the operational reliability.

In a step 27 of FIG. 2, the central user 1 subsequently generates a third life list of the users that successfully returned to the online state after the new operating parameterization. By appropriately specifying the aforementioned minimum period of time, or an additional wait time of the central user 1, it can be ensured that the other users 2 . . . 5 have enough time to return to the online state with the new operating parameterization. In a query 28 (step 28 depicted in FIG. 2), the third life list is compared with the first life list that was generated by the central user 1 at the beginning of the procedure (step 21 in FIG. 2). If the content of two lists is identical, the central user 1 sends the other users 2 . . . 5 a confirmation message T2 in a step 29. This confirmation message T2 is to inform the other users 2 . . . 5 that the parameter modification was successfully completed.

Meanwhile, through a query 45 (step 45) as illustrated in FIG. 3, the user 2 waits for a predefined minimum period of time. The user 2 keeps waiting until a predetermined period of time expires or until a confirmation message is received. If the user 2, did not wait for a predetermined period of time (answer “No” to query 45), the user 2 is queried through a query 46 (step 46) about whether he or she received the confirmation message T2. That is, as depicted in FIG. 3, if the user 2 did not wait for a predetermined period of time (answer “No” to query 45) and the confirmation message is not received (answer “No” to query 46), then the user 2 waits for the expiration of the time period or until the confirmation message is received.

On the other hand, if the predefined minimum period of time has not expired, answer “No” to query 45 depicted in FIG. 3, and the user 2 receives the confirmation message T2, answer “Yes” to query 46 depicted in FIG. 3 (that would indicate that all users were able to switch to the new operating parameterization), the procedure ends for the user 2 with the successful setting of the new operating parameterization.

If, on the other hand, no confirmation message is received within this minimum period of time, i.e., if the query 45 was answered with “yes” as depicted in FIG. 3 (meaning that the predefined period of time has expired and the user did not receive the confirmation message T2), the user 2 returns to the offline state in a step 47, readopts the old operating parameters, and returns to the online state with the old operating parameterization. In this case, the procedure is terminated when the original state is restored.

Returning to the operations in the central user 2, if the query 28 of FIG. 2 shows that the third life list is different from the first life list, then at least one of the other users 2 . . . 5 failed to correctly carry out the reparameterization. Consequently, the central user 1 reverts to the offline state in a step 30 depicted in FIG. 2. Only after the elapse of a further predefined minimum period of time depicted as a delay 31 (step 31 depicted in FIG. 2), the central user 1 returns to the online state with the original operating parameterization at step 32 depicted in FIG. 2, and the procedure is then aborted depicted in FIG. 2 as an “end” stemming from the step 32. An appropriate specification of the wait time before the renewed return to the online state ensures that the other users 2 . . . 5 have detected the absence of the confirmation message T2 and have gone into the offline state. Thus, the users with different operating parameterizations are at no time simultaneously in the online state.

As a possible variation, the confirmation message T2 is an acknowledged message, the receipt of which is indicated by the other users 2 . . . 5 to the central user 1 by a reply message. This reply message ensures a functioning communication at the end of the procedure, since all the users have both sent and received messages with the new operating parameterization.

Turning back to the user 1, generating the third life list in the step 27 depicted in FIG. 2 and checking this life list in the step 28 of FIG. 2 serves to verify that all of the other users 2 . . . 5 in the network have returned to the online state with the new operating parameterization. As an alternative, the central user 1, after returning to the online state, could send a query message to the other users 2 . . . 5 in the network to verify that the other users 2 . . . 5 returned to the online state with the new operating parameterization. The described exemplary embodiment with the third life list, however, may be considered a less complex solution because an existing FDL service of the PROFIBUS specification is used. This service is based on a query of the other users through a query message.

The request message T1 sent by the central user 1 in step 21 as illustrated in the sequence of FIG. 2 can be sent simultaneously to all of the other users 2 . . . 5 in the network as an unacknowledged PROFIBUS broadcast message. For reasons of reliability, for example, the message may optionally be sent more than once to increase the probability that it is received by all of the other users 2 . . . 5 in the network. The advantage of this variant is that the switch to the new parameterization is initiated simultaneously and occurs rapidly.

In another variant, the central user 1 can send request messages T1 successively to all of the other users 2 . . . 5 in the network in the form of acknowledged PROFIBUS messages. The advantage of this variant is that the acknowledge message is a receipt confirmation by the addressed users.

Accordingly, in the exemplary embodiment, the procedure is initiated by a central user. If the central user has access to the network configuration, a modified configuration can be easily implemented by a new operating parameterization of the network users.

All the other users can be reparameterized at the initiative of the central user. Furthermore, the method according to the exemplary embodiment can be made fault tolerant. That is, in the event of a fault, for example, if a new baud rate does not work because the distances between the individual users are too great, the users revert to their original setting. As a result, an automation system remains operational. Accordingly, it may be possible to exclude the problem of a permanent fault in the communication within an automation system.

To implement the method according to the exemplary embodiment of the present invention, it is possible essentially to use existing data link layer-2 and service layer-4 communication mechanisms available in the PROFIBUS specification, for example, transport connections and generating a life list, respectively. Only a few new mechanisms need to be implemented to carry out the method according to the exemplary, non-limiting embodiment of the present invention.

In the event of a fault, the central user can provide information as to which of the other users did not correctly adopt the reparameterization. As a result, the cause of the fault can be isolated.

A configuration device can calculate the respective wait times (predetermined periods of time) as a function of the type and number of users and the current and new operating parameterization. The wait times can then be communicated to the individual users by way of messages before the reconfiguration procedure is started. As an alternative, the wait times may be predefined as a standard in each user and communicated to the configuration device in messages for the verification before the respective start of the reconfiguration procedure. These exemplary procedures for setting the wait times enable a flexible configuration of the wait times and increase the operational reliability.

The above description of illustrative, non-limiting embodiments and variations thereof has been given by way of an example. The above and other features of the invention including various novel method steps and components have been particularly described with reference to the accompanying drawings and pointed out in the claims. It will be understood that the particular process and construction of parts embodying the present invention is shown by way of an illustration only and not as a limitation of the present invention. The principles and features of this present invention may be employed in varied and numerous embodiments without departing from the scope of the present invention as defined by the appended claims and equivalents thereof.

1. A method for modifying a parameter for an operation of a network having a plurality of users, the method comprising:
initiating, by a central user, the parameter modification, by sending a request message for the modification of the parameter during the network operation to other users in the network;
the central user goes to an offline state for a first predefined minimum period of time, during which the central user does not take part in data traffic within the network;
after receiving the request message, the other users go into the offline state for a second predefined minimum period of time;
after elapse of the first predefined minimum period of time, the central user returning to an online state with a new operating parameterization; and
after elapse of the second predefined minimum period of time, the other users returning to the online state with the new operating parameterization,
wherein the first and the second minimum periods of time for the offline state are specified such that users with different operating parameterizations are not simultaneously in the online state.

2. The method as claimed in claim 1, wherein the request message is simultaneously sent in a form of a broadcast message to the other users.

3. The method as claimed in claim 1, wherein the request message is a message addressed to and acknowledged by an individual user, and the request message is sent successively to each of the other users.

4. The method as claimed in claim 1, wherein the network is based on a PROFIBUS specification.

5. The method as claimed in claim 1, wherein, after the returning to the online state, the central user uses a query message to check whether all of the other users in the network have returned to the online state with the new operating parameterization.

6. The method as claimed in claim 5, wherein the request message is simultaneously sent in a form of a broadcast message to the other users.

7. The method as claimed in claim 5, wherein the request message is a message addressed to and acknowledged by an individual user, and the request message is sent successively to each of the other users.

8. The method as claimed in claim 5, wherein:
if all of the other users have returned to the online state with the new operating parameterization, the central user sends a confirmation message to inform the other users that the parameter modification was carried out correctly,
if at least one of the other users failed to return to the online state with the new operating parameterization,
the central user does not send the confirmation message to the other users,
the central user goes to the offline state, and
after elapse of a third minimum period of time, the central user returns to the online state with old operating parameterization, and
if the other users fail to receive a confirmation message after an elapse of a fourth minimum period of time, the other users go into the offline state and return to the online state with the old operating parameterization.

9. The method as claimed in claim 8, wherein the request message is simultaneously sent in a form of a broadcast message to the other users.

10. The method as claimed in claim 8, wherein the request message is a message addressed to and acknowledged by an individual user, and the request message is sent successively to each of the other users.

11. The method as claimed in claim 8, wherein receipt of the conformation message is acknowledge by the other users in the network.

12. The method as claimed in claim 11, wherein the request message is simultaneously sent in a form of a broadcast message to the other users.

13. The method as claimed in claim 11, wherein the request message is a message addressed to and acknowledged by an individual user, and the request message is sent successively to each of the other users.

14. A user for carrying out a method for modifying a parameter for an operation of a network, the user comprising modules for being configured as at least one of:
a central user, which:
initiates the parameter modification by sending a request message for the parameter modification to other users during the network operation, and
after sending the request message, the central user switches to an offline state for a predefined minimum period of time during which the central user does not take part in data traffic within the network, and
after an elapse of the predefined minimum period of time, the central user returns to an online state with the new operating parameterization, and
one of the other users, which:
goes into an offline state for a second predefined minimum period of time after receiving the request message, and
the other user returns to the online state with the new operating parameterization after elapse of the second predefined minimum period of time,
wherein the first and second minimum period of times for the offline state are set so that users with different operating parameterizations are not in the online state simultaneously.

15. The user according to claim 14, wherein when the user is configured as the central user, the user performs as follows:
prior to sending the request message, the central user generates a first life list with a list of all of the users that are in the online state in the network,
after the sending of the request message, the central user generates a second life list indicating all of the users that are in the online state in the network, and
only when the second life list indicates that the central user is the only user in the online state in the network, the central user goes to the offline state for the reparameterization.
